(19) United States
(12) Patent Application Publication
(10) Pub. No.: US 2007/0298142 A1
(43) Pub. Date: Dec. 27, 2007

(54) Morinda Citrifolia Enhanced Products For Administration To Animals

(76) Inventors: Richard G. Godbee, Minden, NV (US); Claude Jarake Jensen, Cedar Hills, UT (US); Bryant Wadsworth, Highland, UT (US); J. Xu, Madison, WI (US); A.C. McSloy, London (GB); B. K. Anderson, Spring Green, WI (US); S. F. Peek, Verona, WI (US); B. J. Darien, Madison, WI (US)

Correspondence Address: KIRTON AND MCCONKIE, 60 EAST SOUTH TEMPLE,, SUITE 1800, SALT LAKE CITY, UT, 84111, US

(21) Appl. No.: 11/624,571

(22) Filed: Jan. 18, 2007

Related U.S. Application Data
(60) Provisional application No. 60/760,428, filed on Jan. 20, 2006.
(60) Provisional application No. 60/760,456, filed on Jan. 20, 2006.
(60) Provisional application No. 60/760,430, filed on Jan. 20, 2006.
(60) Provisional application No. 60/809,567, filed on May 31, 2006.

(51) Int. Cl. A23K 1/00; A23L 1/03; A23L 1/10; A23L 1/20; A23L 1/217; A23L 1/30; A23L 1/302; A23L 1/304

(52) U.S. Cl. 426/2; 426/630; 426/72; 426/73

(57) ABSTRACT

Both liquid and dry form Morinda citrifolia enhanced animal food products are provides. Both contain pasteurized fruit puree and other M. citifolia plant products.

### RELATED APPLICATIONS

This application claims priority to U.S. Patent Application Ser. No. 60/760,428, filed Jan. 20, 2006, entitled “Morinda Citrifolia Enhanced Products for Administration to Animal,” and U.S. Patent Application Ser. No. 60/760,456, filed Jan. 20, 2006, entitled “Methods for administering Morinda Citrifolia Based Food Additives to Animals;” and U.S. Patent Application Ser. No. 60/760,430, filed Jan. 20, 2006, entitled “Physiological Improvements in Animals Resulting from Administration of Morinda Citifolia;” and U.S. Patent Application Ser. No. 60/809,567, filed May 31, 2006, entitled “Morinda Citrifolia Compositions as Cox-2, TNF-A, IL-1B, IL-8 and IL-6 Inhibitors.”

### BACKGROUND

1. Field of the Invention

The field of the invention relates to products which may be administered to various animals, and more particularly to products enhanced with Morinda citrifolia.

2. Background

Animal food products designed for domestic animals, livestock, or pets are generally and preferably prepared as full-feeding foods, which means that the particular composition contains all the necessary nutrients and supplements needed to maintain the health and vigor of the pet. The food composition is balanced in nutrition so that a diet limited to that particular feed will fulfill all of the animal's nutritional needs. The typical ingredients contained within an animal food formulation are protein, carbohydrates, fat, vitamins and minerals. Each of these is present in varying percentages by weight of the specific formulation or composition, sufficient to meet the complete nutritional requirements of the animal. In addition, other ingredients may be added depending upon the specific needs of the animal for which the food is intended.

A wide variety of different animal food formulations are commercially available. In the past, the nutrients or ingredients in these formulations were not typically designed to provide specific advantages to an animal if desired or needed. Recently however, animal food formulations have been designed with a specific goal in mind. Many animal food formulations available on the market today are specialized catering to animals of different ages, different breeds, or those with certain needs, such as obesity, bone loss, weight gain, diseases or maladies. Other formulations address different energy requirements among animals. An additional segment of the animal food market incorporates differences in ingredient usage or product form, which tend to lend themselves to more attractive tastes or varieties.

For example, animal food may be specifically designed as a selective COX-2 inhibitor. Eicosanoids are continuously synthesized in membrane from 20-carbon fatty acid chains that contain at least three double bonds. There are four major classes of eicosanoids—prostaglandins, prostacyclins, thromboxanes, and leukitrienes—and they all are made mainly from arachidonic acid. The synthesis of all but the leukotrienes involve the enzyme cyclooxygenase (COX), which has two distinct isozymes: the constitutive COX-1 and the inaudible COX-2. These synthetic pathways are targets for a large number of therapeutic drugs becasue eicosanoids play an important part in pain, fever, and inflammation. For example, non-steroidal anti-inflammatory drugs (NSAIDs) such as aspirin, ibuprofen, Celebrex® and Vioxx® reduce inflammation through the inhibition of COX, resulting in blockage of the first oxidation step. In addition, inhibition of COX has been linked to a number of other benefits, such as preventing and treating cancer, preventing pre-term delivery and/or treating Alzheimer's disease.

In addition to COX, the inhibition of cytokines, specifically Interleukin-1β (IL-1β), Interleukin-6 (IL-6), and Tumor Necrosis Factor-α (TNF-α), has proven to have many clinical utilities. In general, cytokines are intercellular regulatory proteins that mediate a multiplicity of immunologic biological functions, and in certain pathological situations, particularly autoimmune diseases, chronic inflammatory diseases, and some leukemias, the production of cytokines are disregulated.

In the past, indigenous residents of South Pacific islands have noted health benefits for themselves and their animals by ingesting the Morinda citrifolia fruit sometimes called “Noni.”Although some animals, such a pigs, have been documented consuming the fruit in its natural state, most animals have difficulty consuming and digesting whole naturally occurring Morinda citrifolia fruit. Because of its strong smell and taste, many animals will not consume the product and avoid contact with the fruit and seeds. Since the fruit does not have a limited shelf life and is therefore very difficult to ship from the South Pacific, it is impractical to import and feed the fruit to animals in North America. In addition, while some large animals may benefit from consuming the whole fruit, poultry, small mammals and fish would find it difficult to penetrate the outer layer of the fruit and receive any substantial benefit from the small amount of fruit that they could consume.

Feeding fruit to animals also results in a feeding area which would soon become littered with the rotting remains of the fruit. As a result, while some animals have been able to take advantage of the benefits of naturally occurring fruit, the whole fruit has never been a viable food for domestic animals.

High morbidity among young farm animals is a problem, which can result in severe financial losses to farmers and ranchers. The current methods of controlling morbidity involve a standard oat or gain diet for livestock and fowl, inoculation and antibiotics.

In young cattle (“calves”), this problem is particularly significant. The weaning, processing and transport of stockers is known to be very stressful and often leads to high morbidity and mortality rates. For example, in six year study over 15% of stocker cattle exhibited bovine respiratory disease (BRD), and approximately 70% of feedlot death losses are attributed to BRD. However, death losses are often not the largest costs. Weight loss, lower daily gain, carcass degradation, medicine costs and drug residues in the carcass can amount to $50.00-$100.00 per animal without death loss.

A drop in frequency and duration of eating and drinking are good indicators of morbidity. The dry matter feed intake for calves during the first 28 days in the feedlot has been shown to be 32% less in sick calves than in their healthy counterparts; additionally the average daily weight gain during this period was 0.01 Kg (0.02 lbs) as compared with normal weight gain of 0.59 Kg (1.3 lbs). Thus nutritional interventions must take into account that the calves which are most sick are the one who are least likely to obtain the nutrition they need through top dressing of feed.

Preconditioned of calves by vaccinating, bunk breaking them prior to weaning, and/or prophylactic administration of antibiotics often reduces the morbidity and morality during the initial 2-4 weeks following transporting to a new premise. The inability of the rancher to recover the costs associated with preconditioning has inhibited the adoption of these practices.

It is well established that good nutrition strengthens immunity in cattle. The common addition of immune stimulant nutrients such as zinc and vitamin E to the diet of stocker cattle provides essential building blocks for building a strong immune defense. Nevertheless the published research on nutritional intervention studies have not been consistently positive indicating that an unidentified deficiency still existed in the formulations studied.

Because most of the common medical treatments for the numerous medical problems discussed above can involve serious side effects, compositions containing natural products and nutraceuticals that would treat these diseases and syndromes with less contraindications and diminish the development of antibiotic resistance are highly desirable, not only to relieve suffering in the animals but also to improve the quality of meat and human health.

### SUMMARY OF THE INVENTION

The present invention is directed to various formulas and methods of administering various Morinda citrifolia enhances products to animals to improve physiological condition and to ameliorate and/or prevent various maladies. Therefore, preferred embodiments of the present invention provide a M. citrifolia enhanced product which may be administered to animals. Some embodiments provide an animal product having significant health benefits.

Some embodiments of the present invention relate to various methods of using specially processed components of the Indian Mulberry or Morinda citrifolia L. plant to inhibit COX-2, TNF-α, IL-8 & IL-6.

Some embodiments of the invention include one or more processed Morinda citrifolia components such as: extract from the leaves of Morinda citrifolia, leaf hot water extract, processed Morinda citrifolia leaf ethanol extract, processed Morinda citrifolia leaf steam distillation extract, Morinda citrifolia fruit juice, Morinda citrifolia extract, Morinda citrifolia dietary fiber, Morinda citrifolia puree juice. Morinda citrifolia puree, Morinda citrifolia fruit juice concentrate, Morinda citrifolia puree juice concentrate, freeze concentrated Morinda citrifolia fruit juice, and evaporated concentration of Mirinda citrifolia fruit juice, whole Morinda citrifolia fruit in fresh, whole dried Morinda citrifolia fruit, power or solvent extracted forms as well as enzyme treated Morinda citrifolia seeds, or any other processed Morinda citrifolia seed (i.e. roasting, blanching, microwaving, heat treatment, soaking in water or water solutions of various salts or chemical compounds), whole Morinda citrifolia fruit with blossoms or flowers attached, leaf extracts, leaf juice, and defatted and untreated seed extracts.

Preferred embodiments of the present invention provide delivery systems, methods, and apparatus for providing to animals food products containing Morinda citrifolia puree and other additives such as seed extracts, fatty acids and minerals. Examples of these delivery systems include pellets, extruded nuggets, extruded flakes, sinking nuggets, delivery in liquid form via a water system or lick tank system, semi-solid and gelatinous forms, low moisture gels, low moisture gel pellets, crumble, mash, loose feed, sweet feed, and liquid drenching. The present invention contemplates administering these various forms of Morinda citrifolia enhanced products by either integrating the products into the feed typically provided for the animal, or as a top dressing. Other administration methods include colostrums administered to newborn calves soon after birth, or dipping with Morinda citrifolia enhanced products to ameliorate mastitis.

### BRIEF DESCRIPTION OF THE DRAWINGS

In order that the matter in which the above-recited and other advantages of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a depiction of a liquid form delivery apparatus;

FIG. 2 is a depiction of a solid lick block; and

FIG. 3 is a depiction of a delivery system for solid form products such as crumble, pellets, flakes or nuggets.

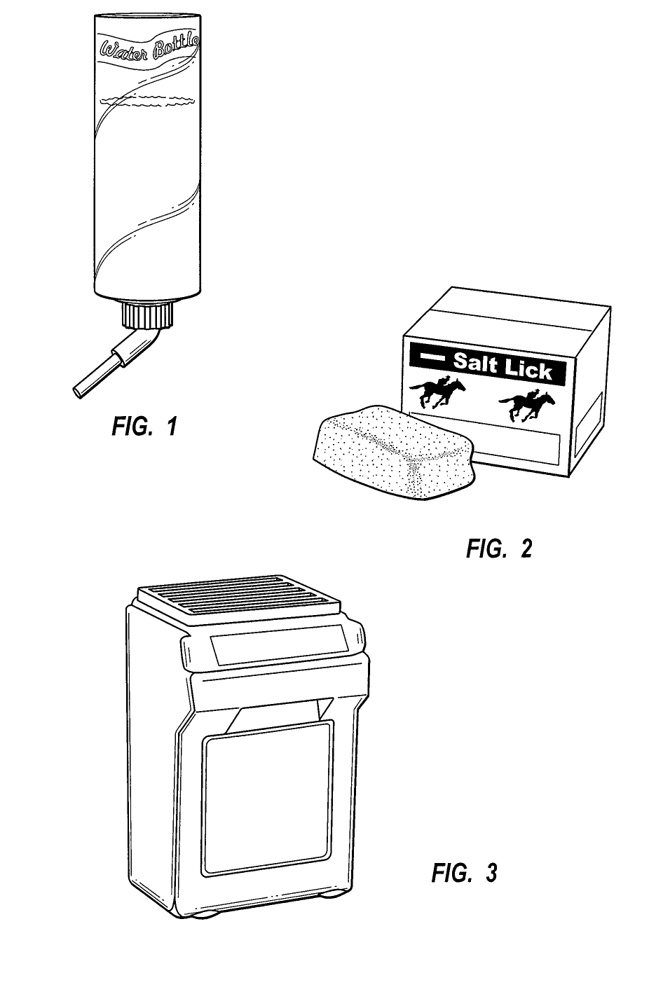

### DEATAILED DESCRIPTION OF THE PREFFERED EMBODIMENTS

The present invention contemplates administering various forms of M. citrifolia with and without additional nutrients. Non-limiting examples of products which may be administered to animals include: M. citrifolia plus glycosaminoglycans, M. citrifolia plus hyaluronic acid, M. citrifolia plus glucosimine HCl, M. citrifolia plus glucosamine sulfate, and M. citrifolia plus chondroitin sulfate. Other non limiting examples of formulations containing M. citrifolia which may be administered to animals include: M. citrifolia plus essential amino acids, M. citrifolia plus essential fatty acids, M. citrifolia plus long chain fatty acids, M. citrifolia plus omega 3 fatty acids, M. citrifolia omega 6 fatty acids, M. citrifolia plus macro minerals, M. citrifolia plus micro minerals, M. citrifolia plus peptides chains, M. citrifolia plus branched chain amino acids, M. citrifolia puree plus whole noni seeds, M. citrifolia puree plus whole roasted noni seeds, M. citrifolia puree plus whole roasted defatted noni seeds, M. citrifolia puree plus roasted cracked noni seeds defatted, M. citrifolia puree plus roasted cracked noni seeds, M. citrifolia puree plus roasted ground noni seeds, M. citrifolia puree plus roasted ground noni seeds defatted, M. citrifolia puree plus roasted flaked noni defatted seeds, M. citrifolia puree plus roasted flaked noni seeds, M. citrifolia puree plus roasted extruded noni defatted seeds, and M. citrifolia puree plus roasted extruded noni seeds and seed extracts.

1. General Description of the Morinda citrifolia L. Plant The Indian Mulberry or Morinda citrifolia plant, known scientifically as Morinda citrifolia L. (“Morinda citrifolia ”), is a shrub or small tree up to 10 m in height. The leaves are oppositely arranged with an elliptic to ovate form. The small white flowers are contained in a fleshy, globose, head-like cluster. The fruits are large, fleshy, and ovoid. At maturity, they are creamy-white and edible, but have an unpleasant taste and odor. The plant is native to Southeast Asia and has spread in early times to a vast area from India to eastern Polynesia. It grows randomly in the wild, and it has been cultivated in plantations and small individual growing plots. The Morinda citrifolia flowers are small, white, three to five lobed, tubular, fragrant, and about 1.25 cm long. The flowers develop into compound fruits composed of many small drupes fused into an ovoid, ellipsoid or roundish, lumpy body, with waxy, white, or greenish-white or yellowish, semi-translucent skin. The fruit contains “eyes” on its surface, similar to a potato. The fruit is juicy, bitter, dull-yellow or yellowish-white, and contains numerous red-brown, hard, oblong-triangular, winged 2-celled stones, each containing four seeds. When fully ripe, the fruit has a pronounced odor like rancid cheese. Although the fruit has been eaten by several nationalities as food, the most common use of the Morinda citrifolia plant had traditionally been as a red and yellow dye source.

2. Processing Morinda citrifolia Leaves

The leaves of the Morinda citrifolia plant are one possible component of the Morinda citrifolia plant that may be present in some compositions of the present invention. For example, some compositions comprise leaf extract and/or leaf juice as described further herein. Some compositions comprise a leaf serum that is comprised of both leaf extract and fruit juice obtained from the Morinda citrifolia plant. Some compositions of the present invention comprise leaf serum and/or various leaf extracts as incorporated into a nutraceutical product (“nutraceutical” herein referring to any drug or product designed to improve the health of living organisms such as human beings or other animals).

In some embodiments of the present invention, the Morinda citrifolia leaf extracts are obtained using the following process. First, relatively dry leaves from the Morinda citrifolia L. plant are collected, cut into small pieces, and placed into a crushing device—preferably a hydraulic press—where the leaf pieces are crushed. In some embodiments, the crushed leaf pieces are then percolated with an alcohol such as ethanol, methanol, ethyl acetate, or other alcohol-based derivatives using methods known in the art. Next, in some embodiments, the alcohol and all alcohol-soluble ingredients are extracted from the crushed leaf pieces, leaving a leaf extract that is then reduced with heat to remove all the liquid therefrom. The resulting dry leaf extract will herein be referred to as the “primary leaf extract.”

In some embodiments of the present invention, the primary leaf extract is pasteurized to at least partially sterilize the extract and destroy objectionable organisms. The primary leaf extract is pasteurized preferably at a temperature ranging from 70 to 80 degrees Celsius and for a period of time sufficient to destroy any objectionable organisms without major chemical alteration of the extract. Pasteurization may also be accomplished according to various radiation techniques or methods.

In some embodiments of the present invention, the pasteurized primary leaf extract is placed into a centrifuge decanter where it is centrifuged to remove or separate any remaining leaf juice therein from other materials, including chlorophyll. Once the centrifuge cycle is completed, the leaf extract is in a relatively purified state. This purified leaf extract is then pasteurized again in a similar manner as discussed above to obtain a purified primary leaf extract.

Preferably, the primary leaf extract, whether pasteurized and/or purified, is further fractioned into two individual fractions: a dry hexane fraction, and an aqueous methanol fraction. This is accomplished preferably via a gas chromatograph containing silicon dioxide and CH₂—Cl₂—MeOH ingredients using methods well known in the art. in some embodiments of the present invention, the methanol fraction is further fractioned to obtain secondary methanol fractions. In some embodiments, the hexane fraction is further fractioned to obtain secondary hexane fractions.

One or more of the leaf extracts, including the primary leaf extract, the hexane fraction, methanol fraction, or any of the secondary hexane or methanol fractions may be combined with the fruit juice of the fruit of the Morinda citrifolia plant to obtain a leaf serum (the process of obtaining the fruit juice to be described further herein). In some embodiments, the leaf serum is packaged and frozen ready for shipment; in others, it is further incorporated into a nutraceutical product as explained herein.

3. Processing Morinda citrifolia Fruit

Some embodimentsof the present invention include a composition comprising fruit juice of the Morinda citrifolia plant. Because the Morinda citrifolia fruit is for all practical purposes inedible, the fruit must be processed in order to make it palatable for human consumption and included in the compositions of the present invention. Processed Morinda citrifolia fruit juice can be prepared by separating seeds and peels from the juice and pulp of a ripened Morinda citrifolia fruit; filtering the pulp from the juice; and packaging the juice. Alternatively, rather than packaging the juice, the juice can be immediately included as an ingredient in another product, frozen or pasteurized. In some embodiments of the present invention, the juice and pulp can be pureed into a homogenous blend to be mixed with other ingredients. Other processes include freeze drying the fruit and juice. The fruit and juice can be reconstituted during production of the final juice product. Still other processes may include air drying the fruit and juices prior to being masticated.

In a currently preferred process of producing Morinda citrifolia fruit juice, the fruit is either hand picked or picked by mechanical equipment. The fruit can be harvested when it is as least in inch (2-3 cm) and up to 12 inches (24-36 cm) in diameter. The fruit preferably has a color ranging from a dark green through a yellow-green up to a white color, and gradations of color in between. The fruit is thoroughly cleaned after harvesting and before any processing occurs.

The fruit is allowed to ripen or age from 0 to 14 days, but preferably for 2 to 3 days. The fruit is ripened or aged by being placed on equipment so that the fruit does not contact the ground. The fruit is preferably covered with a cloth or netting material during aging, but the fruit can be aged without being covered. When ready for further processing the fruit is light in color, such as a light green, light yellow, white or translucent color. The fruit is inspected for spoilage or for excessive green color and firmness. Spoiled and hard green fruit is separated from the acceptable fruit.

The ripened and aged fruit is preferably placed in plastic lined containers for further processing and transport. The containers of aged fruit can be held from 0 to 30 days, but preferably the fruit containers are held for 7 to 14 days before processing. The containers can optionally be sorted under refrigerated conditions prior to further processing. The fruit in unpacked from the storage containers and is processed through a manual or mechanical separator. The seeds and peel are separated from the juice and pulp.

The juice and pulp can be packaged into containers for storage and transport. Alternatively, the juice and pulp can be immediately processed into a finished juice product. The containers can be stored in refrigerated, frozen, or room temperature conditions. The Morinda citrifolia juice and pulp are preferably blended in a homogenous blend, after which they may be mixed with other ingredients, such as flavorings, sweeteners, nutritional ingredients, botanicals, and colorings. The finished juice product is preferably heated and pasteurized at a minimum temperature of 83° C. or higher up to 100° C. Another product manufactured is Morinda citrifolia puree and puree juice, in either concentrate or diluted form. Puree is essentially the pulp separated from the seeds and is different than the fruit juice product described herein.

The product is filled and sealed into a final container of plastic, glass, or another suitable material that can withstand the processing temperatures. The containers are maintained at the filling temperature or may be cooled rapidly and then placed in a shipping container. The shipping containers are preferably wrapped with a material and in a manner to maintain or control the temperature of the product in the final containers.

The juice and pulp may be further processed by separating the pulp from the juice through filtering equipment. The filtering equipment preferably consists of, but is not limited to, a centrifuge decanter, a screen filter with a size from 1 micron up to 2000 microns. more preferably less than 500 microns, a filter press, a reverse osmosis filtration device, and any other standard commercial filtration devices. The operating filter pressure preferably ranges from 0.1 psig up to about 1000 psig. The flow rate preferably ranges from 0.1 g.p.m. up to 1000 g.p.m., and more preferably between 5 and 50 g.p.m. The wet pulp is washed and filtered at least once and up to 10 times to remove any juice from the pulp. The resulting pulp extract typically has a fiber content of 10 to 40 percent by weight. The resulting pulp extract is preferably pasteurized at a temperature of 83° C. minimum and then packed in drums for further processinf or made into a high fiber product.

4. Processing Morinda citrifolia Seeds

Some Morinda citrifolia compositions of the present invention include seeds from the Morinda citrifolia plant. In some embodiments of the present invention, Morinda citrifolia seeds are processed by pulverizing them into a seed powder in a laboratory mill. In some embodiments, the seed powder is left untreated. In some embodiments, the seed powder is further fefatted by soaking and stirring the powder in hexane—preferably for 1 hour at room temperature (Drug:Hexane—Ratio 1:10). The residue, in some embodiments, is then filtered under vacuum, defatted again (preferably for 30 minutes under the same conditions), and filtered under vacuum again. The powder may be kept overnight in a fume in order to remove the residual hexane.

Still further, in some embodiments of the present invention, the defatted and/or untreated powder is extracted, preferably with ethanol 50% (m/m) for 24 hours at room temperature at a drug solvent ratio of 1:2.

5. Processing Morinda citrifolia Oil

Some embodiments of the present invention may comprise oil extracted from the Morinda citrifolia plant. The method for extracted and processing the oil is described in U.S. patent application Ser. No. 09/384,785, filed on Aug. 27, 1999 and issued as U.S. Pat. No. 6,214,351 on Apr. 10, 2001, which is incorporated by reference herein. The Morinda citrifolia oil typically includes a mixture of several different fatty acids as triglycerides, such as palmitic, stearic, oleic, and linoleic fatty acids, and other fatty acids present in lesser quantities. In addition, the oil preferably includes an antioxidant to inhibit spoilage of the oil. Conventional food grade antioxidants are preferably used.

6. General Discussion of Animal Food Products

Animal food products have become more advanced in their ability to specifically target and cater to specific needs of different animals. Several animal food preparations are disclosed in U.S. Pat. No. 6,737,089 which is incorporated herein in its entirety.

The present invention contemplates administering various forms of the M. citrifolia with additional nutrients. Non-limiting examples of products which may be administered to animals include: M. citrifolia plus glycosaminoglycans, M. citrifolia plus hyaluronic acid, M. citrifolia plus glucosamine HCl, M. citrifolia plus glucosamine sulfate, and M. citrifolia plus chondroitin sulfate. Other non limiting examples of formulations containing M. citrifolia which may be administered to animals include: M. citrifolia plus essential amino acids, M. citrifolia plus essential fatty acids, M. citrifolia plus long chain fatty acids, M. citrifolia plus omega 3 fatty acids, M. citrifolia plus omega 6 fatty acids, M. citrifolia plus macro minerals, M. citrifolia plus micro minerals, M. citrifolia plus peptides chains, M. citrifolia plus branched chain amino acids, M. citrifolia puree plus whole noni seeds, M. citrifolia puree plus whole roasted noni seeds, M. citrifolia puree plus whole roasted defatted noni seeds, M. citrifolia puree plus roasted cracked noni seeds defatted, M. citrifolia puree plus roasted cracked noni seeds, M. citrifolia puree plus roasted ground noni seeds, M. citrifolia puree plus roasted ground noni seeds defatted, M. citrifolia puree plus roasted flaked noni defatted seeds, M. citrifolia puree plus roasted flaked noni seeds, M. citrifolia puree plus roasted extruded noni defatted seeds, and M. citrifolia puree plus roasted extruded noni seeds.

The present invention contemplates administering various forms of M. citrifolia enhanced products. Non-limiting examples of those forms include: pellet, extruded nugget, extruded flake, sinking nugget, liquid via water system, liquid via lick-tank system, semi-solid, gel low moisture gel, and low moisture gel pellet.

Method of delivery of the M. citrifolia enhanced products may be very important. Some non-limiting examples of methods of delivery include top dressing feed with a M. citrifolia product, adding it to the feeding practices used for new calves including adding M. citrifolia product to the colostrums administered to new born calves soon after birth, dipping with M. citrifolia enhanced products to ameliorate mastitis in the dairy industry.

There are several considerations that may be included in the assessment of what form of administration the M. citrifolia product should take. Some non-limiting examples of consideration include: palatability—will the cows/animals eat the product, suggested intake—what will be the proper dosage, milk flavor—will it taint the flavor if the milk in the dairy industry, incorporation into the feed—can it conveniently be added to the feed without significantly reducing its effectiveness, and uniformity of mixing—can it be mixed into the feed in a uniform and consistent way so that we can be sure that each animal is getting the proper dosage.

We contemplate thoroughly mixing the M. citrifolia enhanced products with the food consumed by the animals. In a non-limiting example we propose mixing the M. citrifolia enhanced products with grains or hay. In another non-limiting example we propose missing the M. citrifolia with a water medicator.

7. Compositions and Their Use

The present invention features compositions and methods for administering various M. citrifolia enhanced products to animals to improve various physiological conditions. For example the products of the present invention may be utilized to enhance immunity against gram negative infections. Embodiments of the present invention also comprise methods for internally and/or externally introducing a Morinda citrifolia composition to the body of an animal. Several embodiments of the Morinda citrifolia compositions comprise various different ingredients, each embodiment comprising on or more forms of a processed Morinda citrifolia component as taught and explained herein.

Some embodiments of the invention include one or more processed Morinda citrifolia components such as: extract from the leaves of Morinda citrifolia, leaf hot water extract, processed Morinda citrifolia leaf ethanol extract, processed Morinda citrifolia leaf steam distillation extract, Morinda citrifolia fruit juice, Morinda citrifolia extract, Morinda citrifolia dietary fiber, Morinda citrifolia puree juice, Morinda citrifolia puree, Morinda citrifolia fruit juice concentrate, Morinda citrifolia puree juice concentrate, freeze concentrated Morinda citrifolia fruit juice, and evaporated concentration of Morinda citrifolia fruit juice whole Morinda citrifolia fruit in fresh, whole dried Morinda citrifolia fruit, powder or solvent extracted forms as well as enzyme treated Morinda citrifolia seeds, or any other processed Morinda citrifolia seed (i.e. roasting, blanching, microwaving, heat treatment, soaking in water or water solutions of various salts or chemical compounds), whole Morinda citrifolia fruit with blossoms or flowers attached, leaf extracts, leaf juice, and defatted and untreated seed extracts. Compositions of the present invention may also include various other ingredients. Examples of other ingredients include, but are not limited to: artificial flavoring, other natural juices or juice concentrates such as a natural grape juice concentrate or a natural blueberry juice concentrate; carrier ingredients; and others as will be further explained herein.

The present invention contemplates administering various forms of M. citrifolia with additional nutrients. Non-limiting examples of products which may be administered to animals include: M. citrifolia plus glycosaminoglycans, M. citrifolia plus hyaluronic acid, M. citrifolia plus glucosamine HCl, M. citrifolia glucosamine sulfate, and M. citrifolia plus chondroitin sulfate. Other non limiting examples of formulation containing M. citrifolia which may be administering to animals include: M. citrifolia plus essential amino acids, M. citrifolia plus essential fatty acids, M. citrifolia plus long chain fatty acids, M. citrifolia plus omega 3 fatty acids, M. citrifolia plus omega 6 fatty acids, M. citrifolia plus macro minerals, M. citrifolia plus micro minerals, M. citrifolia plus peptides chains, M. citrifolia plus branched chain amino acids, M. citrifolia puree plus whole noni seeds, M. citrifolia puree plus whole roasted noni seeds, M. citrifolia puree plus whole roasted defatted noni seeds, M. citrifolia puree plus roasted cracked noni seeds defatted, M. citrifolia puree plus roasted cracked noni seeds, M. citrifolia puree plus roasted ground noni seeds, M. citrifolia puree plus roasted ground noni seeds defatted, M. citrifolia puree plus roasted flaked noni defatted seeds, M. citrifolia puree plus roasted flaked noni seeds, M. citrifolia puree plus roasted extruded noni defatted seeds, M. citrifolia puree plus extracts extruded noni seeds, and M. citrifolia noni puree extracts from roasted extruded noni seeds.

Any compositions having the leaf extract from the Morinda citrifolia leaves, may comprise on or more of the following: the primary leaf extract, the hexane fraction, methanol fraction, the secondary hexane and methanol fractions, the leaf serum, or the nutraceutical leaf product.

In some embodiments of the present invention, active ingredients or compounds of Morinda citrifolia components may be extracted out using various procedures and processes commonly known in the art. For instance, the active ingredients may be isolated and extracted using alcohol or alcohol-based solutions, such as methanol, ethanol, and ethyl acetate, and other alcohol-based derivatives using methods known in the art. These active ingredients or compounds may be isolated and further fractioned or separated from one another into their constituent parts. Preferably, the compounds are separated or fractioned to identify and isolate any active ingredients that might help to prevent disease, enhance health, or perform other similar functions. In addition, the compounds may be fractioned or separated into their constituent parts to identify and isolate any critical or dependent interactions that might provide the same health-benefiting functions just mentioned.

Any components and compositions of Morinda citrifolia may be further incorporated into a nutraceutical product (again, “nutraceutical” herein referring to any product designed to improve the health of living organisms such as humans or other animals). Examples of nutraceutical products may include, but are not limited to: intravenous products, topical dermal products, wound healing products, burn healing and treatment products, first-aid products, antibacterial products, bone healing and treatment products, anti-inflammatory products, eye drops, antifungal products, arthritis treatment products, muscle relaxers, and various nutraceutical and other products as may be further discussed herein.

The compositions of the present invention may be formulated into any of a variety of embodiments, including oral compositions, topical dermal solutions, intravenous solutions, and other products or compositions.

Oral compositions may take the form of, for example, tablets, blouses, lozenges, aqueous or oily suspensions, dispersible powders or granules, emulsions, syrups, or elixirs. Compositions intended for oral use may be prepared according to any method known in the art, and such compositions may contain one or more agents such as sweetening agents, flavoring agents, coloring agents, and preserving agents. They may also contain on or more additional ingredients such as vitamins and minerals, etc. Tablets may be manufactured to contain on or more Morinda citrifolia components in admixture with non-toxic, pharmaceutically acceptable excipients that are suitable for the manufacture of tablets. These exipients may be, for example, inert diluents, granulating and disintegrating agents, binding agents, and lubricating agents. The tablets may be uncoated or they may be coated by known techniques to delay disintegration and absorption in the gastrointestinal tract and thereby provide sustained action over a longer period. For example, a time delay material such as glyceryl monostearate or glyceryl distearate may be used.

Aqueous suspensions may be manufactured to contain the Morinda citrifolia components in admixture with excipients suitable for the manufacture of aqueous suspensions. Examples of such excipients include, but are not limited to: suspending agents such as sodium carboxymethyl-cellulose, methycellulose, hydroxy-propylmethcellulose, sodium alginate, polyvinyl-pyrrolidone, gum tragacanth and gum acacia; dispersing or wetting agents such as a naturally-occurring phosphatide like lecithin, or condensation products of an alkylene oxides with fatty acids such as polyoxyethylene stearate, or condensation products of ethylene oxide with long chain aliphatic alcohols such as heptadecaethylene-oxycetanol, or condensation products of ethylene oxide with partial esters derived from fatty acids and a hexitol such as polyoxyethylene sorbitor monooleate, or condensation products of ethylene oxide with partial esters derived from fatty acids and hexitol anhydrides such as polyethylene sorbitan monoolate.

Typical sweetening agents may include, but are not limited to: natural sugars derived from corn, sugar beets, sugar cane, potatoes, tapioca, or other starch-containing sources that can be chemically or enzymatically converted to crystalline chunks, powders, and/or syrups. Also, sweeteners can comprise artificial or high-intensity sweeteners, some of which may include aspartame, sucralose, stevia, saccharin, etc. The concentration of sweeteners may be between from 0 to 50 percent by weight of the Morinda citrifolia composition, and more preferably between about 1 and 5 percent by weight.

Typical flavoring agents can include, but are not limited to, artificial and/or natural flavoring ingredients that contribute to palatability. The concentration of flavors may range, for example, from 0 to 15 percent by weight of the Morinda citrifolia composition. Coloring agents may include food-grade artificial or natural coloring agents having a concentration ranging from 0 to 10 percent by weight of the Morinda citrifolia composition.

Typical nutritional ingredients may include vitamins, minerals, trace elements, herbs, botanical extracts, bioactive chemicals, and compounds at concentrations from 0 to 10 percent by weight of the Morinda citrifolia composition. Examples of vitamins include, but are not limited to, vitamins A, B1 through B12, C, D, E, Folic Acid, Pantothenic Acid, Biotin, etc. Examples of minerals and trace elements include, but are not limited to, calcium, chromium, copper, cobalt, boron, magnesium, iron, selenium, manganese, molybdenum, potassium, iodine, zinc, phosphorus, etc. Herbs and botanical extracts may include, but are not limited to, alfalfa grass, bee pollen, chlorella powder, Dong Quai powder, Ecchinacca root, Ginko Biloba extract, Horsetail herb, Indian mulberry, Shitake mushroom, spirulina seaweed, grape seed extract, etc. Typical bioactive chemicals may include, but are not limited to, caffeine, ephedrine, L-carnitine, creatine, lycopene, etc.

The ingredients to be utilized in a topical dermal product may include any that are safe for internalizing into the body of a mammal and may exist in various forms, such as gels, lotions, creams, ointments, etc., each comprising on or more carrier agents. The ingredients or carrier agents incorporated into systematically (e.g., intravenously) administered compositions may also comprise any known in the art.

In one exemplary embodiment, a Morinda citrifolia composition of the present invention comprises one or more of a processed Morinda citrifolia component present in an amount by weight between about 0.01 and 100 percent by weight, and preferably between 0.01 and 95 percent by weight. Several embodiments of formulation are included in U.S. Pat. No. 6,214,351, issued on Apr. 10, 2001, which is incorporated in its entirety herein. However, these compositions are only intended to be exemplary, as one ordinarily skilled in the art will recognize other formulations or compositions comprising the processed Morinda citrifolia product.

In other exemplary embodiment, the internal composition comprises the ingredients of: processed Morinda citrifolia fruit juice or puree juice present in an amount by weight between about 0.1-80 percent, processed Morinda citrifolia oil present in an amount by weight between about 0.1-20 percent; and a carrier medium present in an amount by weight between about 20-29 percent. Morinda citrifolia puree juice or fruit juice may also be formulated with a processed Morinda citrifolia dietary fiber product present in similar concentrations.

The juice and pulp can be dried using a variety of methods. The juice and pulp mixture can be pasteurized or enzymatically treated prior to drying. The enzymatic process begins with heating the product to a temperature between 32.9°C. and 57.2°C. It is then treated with either a single enzyme or a combination of enzymes. These enzymes include, but are not limited to, amylase, lipase, protease, cellulase, bromelin, etc. The juice and pulp can be dried with other ingredients, such as those described above in connection with the high fiber product. The typical nutritional profile of the dried juice and pulp is 1 to 20 percent moisture, 0.1 to 15 percent protein, 0.1 to 20 percent fiber, and vitamin and mineral content.

The filtered juice and the water from washing the wet pulp are preferably mixed together. The filtered juice is preferably vacuum evaporated to a brix of 40 to 70 and a moisture of 0.1 to 80 percent. more preferably from 25 to 75 percent. The resulting concentrated Morinda citrifolia juice may or may not be pasteurized. The juice would not be pasteurized in circumstances where the sugar content or water activity was sufficiently low enough to prevent microbial growth. It si packaged for storage, transport and/or further processing.

Animal food products have become more advanced in their ability to specifically target and cater to specific needs of different animals. Several food preparations are disclosed in U.S. Pat. No. 6,737,089 which is incorporated herein in its entirety.

8. Delivery Forms and Systems

The present invention contemplated administering various forms of M. citrifolia enhanced products. Non-limiting examples of those forms include: pellet, extruded nugget, extruded flake, sinking nugget, liquid via water system, liquid via lick-tank system, semi-solid, gel, low moisture gel, and low moisture gel pellet.

### Methods of Delivery

Some non-limiting example of methods of delivery include top dressing feed with a M. citrifolia product, adding it in liquid form to the dry feed normally given that species or drying the M. citrifolia product and adding it in ground, grannular or pellet form. Liquid M. citrifolia products are simply mixed in the proper ratio with other liquid feed. Sinking pellets are used for fish or other water dwelling creatures. The M. citrifolia additives whether liquid or dry are mixed into the feed in a uniform and consistent way so that it can be assured that each animal is getting the proper amount for uniform benefits.

One method for administering the M. citrifolia enhances food products is by administering a large liquid dose or “drenching” (“drenching”) means giving each cow, horse, sheep and/or other animal about a quart or a liter of product at once down the throat of M. citrifolia enhanced products.

### Forms of Administration

The present invention contemplates administering various forms of M. citrifolia enhanced products. Non-limiting examples of those forms include: pellet, extruded nugget, extruded flake, sinking nugget, liquid via water system, liquid via lick-tank system, semi-solid, gel, low moisture gel, low moisture gel pellet.

Method of delivery of the M. citrifolia enhanced products may be very important. Some non-limiting examples of methods of delivery include top dressing feed with a M. citrifolia product, adding it to the feeding practices used for new calves including adding M. citrifolia product to the colostrums administered to new born calves soon after birth, dipping with M. citrifolia enhanced products to ameliorate mastitis in the dairy industry There are several considerations that may be included in the assessment of what form of administration the M. citrifolia product should take. Some non-limiting example of consideration include: palatability—will the cows/animals eat the product, Dosage—what will be the proper dosage, milk flavor—will it taint the flavor of the milk in the dairy industry, incorporation into the feed—can it conveniently be added to the feed without significantly reducing its effectiveness, and uniformity of mixing—can it be mixed into the feed in a uniform and consistent way so that we can be sure that each animal is getting the proper dosage.

We contemplate mixing the M. citrifolia enhanced products with the food consumed by the animals. In a non-limiting example we propose mixing the M. citrifolia enhances products with grains or hay. In another non-limiting example we propose missing the M. citrifolia with a water medicator.

The effect of M. citrifolia enhanced products, M. citrifolia puree for example, on mastitis is of interest. Using a “drench” with a M. citrifolia enhance product, where an afflicted animal is administered a large dose, wherein a non-limiting example of a large does may include more than two ounces, one quart, two quarts, three quarts, more than three quarts on a periodic basis, wherein a non-limiting example of a periodic basis may include once every other day, once a day, twice a day or more than twice a day. Since the somatic cell count (SCC) of each cow is taken periodically, one could see very soon whether or not the M. citrifolia enhanced products were having the desired effect. In another non-limiting example entire herds or groups of animals may be treated as described above in order to ameliorate or prevent undesirable physiological conditions or to enhance or improve desirable physiological conditions.

Decreasing the use of antibiotics may be achieved by administering various M. citrifolia enhanced products in their place.

Several experiments have been conducted which indicate that the taste and smell of M. citrifolia enhanced products does not affect the taste or smell of milk from cattle which have been administered M. citrifolia enhances products, and that the enhanced products are palatable to the animals. Additionally, experiments have shown that success in treating mastitis by infusing the infected quarter with M. citrifolia enhanced products and rubbing M. citrifolia enhanced products on the udder for relief of pain and inflammation. Further Experiments have shown that administering M. citrifolia enhances products to new born calves preents the calves for getting scours. In a non-limiting example new born calves were administered 2 oz. twice a day, decreases the morality rate of new born calves substantially and substantially improved weight gain.

### EXAMPLES

The following examples are given to illustrate various embodiments which have been made or may be made in accordance with the present invention and are given by the way of example only. It is to be understood that the following examples are not all inclusive, comprehensive, or exhaustive of the many types of embodiments of the present invention which can be prepared in accordance with the technology as described herein.

### Example 1

### Calf Trials

In a trial of 100 calves, those receiving two ounces of Tahitian Noni puree twice daily out gained those receiving no treatment by 0.4 kg per day from to weaning. Treatment calves gained more than 8% faster than non treatment calves. This resulted in a 6.33 pound weight advantage at weaning. Average age at weaning was 66 days, average weight at weaning 155 pounds. these results were subjected to a rigorous statistical analysis that found them to be significant at 99.967% for average daily gain and 99.9963% for total gain. A rating of 95% is generally considered to be significant. Bull calves gained at a slightly faster rate than heifers, but these differences were not statistically significant. Fifty bull calves and fifty heifer calves were assigned randomly to treatment or non treatment groups at birth. All calves were weighed at birth and again at weaning to obtain the results reported. Calves were bucket fed pasteurized, whole milk. A customized, calf starter concentrate was offered, free choice, from day one.

### Example 2

### Pig Trials

Noni puree in a gel form was fed to baby pigs in three different trials. In the first trial pigs from 10 litters were identified and divided into four groups in such a way as to minimize differences due to litter and sex. All these pigs were from genetically similar sows and all sired, artificially, by the same boar to minimize genetic differences.

Two days prior to weaning, pigs from two groups were force fed noni puree gel by inserting a tube in their mouths and delivering 5 cc of the gel. Two control groups were no given any treatment. Each group of pigs was weighed at the beginning of the trial and weekly thereafter for three weeks. Here are the results.

First Trial

| | |
|---|---|
| Treated | Not Treated |

| Week | Pen 1 | Pen 1 | Pen 3 | Pen 4 |
|---|---|---|---|---|
| 0 | 335 | 327 | 285 | 338 |
| 1 | 393 | 378 | 325 | 351 |
| 2 | 439 | 346 | 348 | 392 |
| 3 | 495 | 464 | 388 | 437 |
| Total Gain | 160 | 137 | 103 | 99 |

The treated pigs gained a total of 297 pounds compared to 202 pounds for the controls, a 47% advantage for the treated pigs. This is especially noteworthy because there was concern that handling the pigs daily would have a negative effect on their rate of gain. Treated pigs were handled individually on a daily basis while untreated pigs were simply weighed in a weekly basis. If these results could be obtained routinely it would mean an advantage of 2.97 pounds per pig.

In the second trial, 10 litters of pigs from genetically similar sows and sired by the same boar were divided into two groups of five litters each. Litters in the east side of the farrowing house served as one group and the west side of the farrowing house as the second group. Starting at one week of age, the pigs in one group were force fed noni puree for 10 days while the other group received no treatment. Each group was weighed daily. Here are the results.

Second Trial

| Day | Treated | Not Treated |
|---|---|---|
| 23 Aug | 389 | 368 |
| 24 Aug | 402 | 370 (one died) |
| 25 Aug | 403 | 360 |
| 26 Aug | 404 | 362 |
| 27 Aug | 405 | 388 |
| 28 Aug | 460 | 421 |
| 29 Aug | 483 | 477 |
| 30 Aug | 517 | 489 |
| 31 Aug | 538 | 502 |
| 1 Sep | 563 | 531 |
| Total Gain | 174 | 163 |

There were 98 pigs in this trial at the beginning with one dying in the non treated group on the second day. Though pigs in the treated group gained more than those in the non treated group, the result are not conclusive.

At weaning time, the top 22 pigs in each group, treated and not treated, with consideration given to litters and sex, were places in two pens for the third trial. Pigs in the treatment group were continued on non treatment. Each group was weighed at the beginning and weekly thereafter. Here are the results.

Third Trial

| | Treated | Not Treated |
|---|---|---|
| Week | Pen 1 | Pen 2 |
| 0 | 330 | 304 |
| 1 | 360 | 339 |
| 2 | 427 | 356 |
| 3 | 490 | 445 |
| Total Gain | 160 | 141 |

The treated pigs gained 13.5% more than the non-treated, not as great an advantage as in trial # 1, but still amounting to 0.86 pounds per pig. The owner noted that the treated pigs were extremely skittish by the end of the trial, having been handled daily for 31 days, pointing out once more that a more efficient means of administering the product needs to be developed. Force feeding by tube is very labor intensive and disadvantageous to the pigs as a stress factor.

### Example 3

### Dairy Calf Stress Test

Three hundred seventy two dairy calves were entered in a stress trial. These were so-called day old calves were purchased from numerous dairies. Eighty four calves (58 bulls and 26 heifers) received at the farm on day one of the trial were force fed 15 cc of noni puree gel at the time of pickup by inserting a tube in their mouths and squirting the gel back of their tongues. Another 15 cc was given to each calf upon unloading at the farm. Each of these 84 calves were subsequently treated again, morning and evening, for the next six days. A second group of 135 calves (101 bulbs and 34 heifers) received at the farm day two of the trial were fed 15 cc on noni puree gel at the time of pickup and an additional 15 cc at the time of unloading. These 135 calves were subsequently treated morning and evening for two additional days.

A third group of 153 calves (116 bulbs and 37 heifers) received at the farm day 9 of the trial were given no treatment.

All calves, whether on noni puree or not, were also given a 2 cc shot of anti bacteria vaccine upon arrival at the farm.

Calves were examined daily for signs of sickness. A note was made every day on every calf showing clinical signs of scours. Medicines administered by farm personnel were also recorded for each cal. Some calves considered to be too small were sold. These sales were recorded as well as all deaths. here is a summary of the information recorded.

| | ALL CALVES | | |
|---|---|---|---|
| | 7 Day | 3 Day | No |
| | Treatment | Treatment | Treatment |
| No. of Calves | 84 | 135 | 153 |
| Scours Cases | 4 (0.049) | 31 (0.229) | 9 (0.058) |
| Days W/Scours | 13 (0.154) | 132 (0.977) | 26 (0.169) |
| Sold | 5 (0.059) | 3 (0.022) | 3 (0.019) |
| Died | 1 (0.011) | 3 (0.022) | 1 (0.006) |
| Mix V | 8 (0.095) | 26 (0.192) | 3 (0.019) |
| Ex V | 19 (0.226) | 2 (0.014) | 0 (0.000) |
| LA 200 | 27 (0.321) | 3 (0.022) | 0 (0,000) |
| Toxin Blend | 0 (0.000) | 1 (0.007) | 0 (0.000) |
| Poor Doer | 0 (0.000) | 1 (0.007) | 0 (0.000) |
| Chronic Scours | 0 (0.000) | 1 (0.007) | 0 (0.000) |

Numbers in parentheses are percentage based on number of calves, decimals truncated at three places.

| | 7 Day | 3 Day | No |
|---|---|---|---|
| | Treatment | Treatment | Treatment |
| | BULL CALVES ONLY | | |
| No. of Calves | 58 | 101 | 116 |
| Scours Cases | 3 (0.051) | 26 (0.257) | 7 (0.060) |
| Days W/Scours | 10 (0.172) | 101 (1.000) | 21 (0.181) |
| Sold | 1 (0.017) | 1 (0.009) | 3 (0.025) |
| Died | 1 (0.017) | 1 (0.009) | 0 (0.000) |
| Mix V | 6 (0.103) | 14 (0.138) | 3 (0.025) |
| Ex V | 16 (0.275) | 2 (0.019) | 0 (0.000) |
| LA 200 | 22 (0.379) | 2 (0.019) | 0 (0.000) |
| Toxin Blend | 0 (0.000) | 0 (0.000) | 0 (0.000) |
| Poor Doer | 0 (0.000) | 1 (0.009) | 0 (0.000) |
| Chronic Scours | 0 (0.000) | 1 (0.009) | 0 (0.000) |
| | HEIFER CALVES ONLY | | |
| No. of Calves | 26 | 34 | 37 |
| Scours Cases | 1 (0.038) | 5 (0.147) | 2 (0.054) |
| Days W/Scours | 3 (0.115) | 21 (0.617) | 5 (0.135) |
| Sold | 4 (0.153) | 2 (0.058) | 0 (0.000) |
| Died | 0 (0.000) | 2 (0.058) | 1 (0.027) |
| Mix V | 2 (0.076) | 12 (0.352) | 0 (0.000) |
| Ex V | 3 (0.115) | 0 (0.000) | 0 (0.000) |
| LA 200 | 5 (0.192) | 1 (0.029) | 0 (0.000) |
| Toxin Blend | 0 (0.000) | 1 (0.029) | 0 (0.000) |
| Poor Doer | 0 (0.000) | 0 (0.000) | 0 (0,000) |
| Chronic Scours | 0 (0.000) | 0 (0.000) | 0 (0.000) |

Problems with sours were minimal in calves picked up early (the first two day), increased markedly in those picked up during the next four days and then tapered off dramatically during the final six days.

Quick, short term treatment with noni puree at the levels used in this trial did nothing to reduce stress in the animals treated. In fact, treatment for three days seemed to increase stress. Actually, this makes good sense because the treatment itself was stressful. When added on top of the stress of being moved it proved to be a formidable obstacle to the calves involved.

Treatment for seven days proved to be very beneficial compared to treatment for three days, especially considering the high correlation between health problems and time of pickup. There was some visual evidence that calves treated seven days did better overall than any others. There were no readily apparent differences in response due to sex.

### Example 4

### In Vitro Trial on Rumin Fluid

Experiments were conducted to determine if M. citrifolia enhanced products would have any adverse effect on ruminants. The results indicated that it not only will not be detrimental to ruminal fermentation, it may prove to have some significant benefits. Although no major effects on in vitro ruminal fermentation were detected with the addition of Morinda citrifolia extract, some promising results were observed. Although dry matter disappearence and total VFA concentrations were unaffected in this study, inclusion of the extract, particularly at the lower inclusion level (1% of substrate), had significant effects on fermentation end products. This is important because it suggest differences in the energetic efficiency of fermentation and potential differences in the utilization of dietary protein by ruminal microorganisms. Ruminal propionate production is associated with less hydrogen production than either acetate or butyrate production. Typically, when propionate production is enhanced, less methane is produces, resulting in more efficient utilization of energy. Furthermore, propionate can stimulate production in ruminants by serving as a glucogenic substrate. Decrease in branched-chain VFA proportions suggest a decrease in ruminal proteolysis and/or deamination. On most diets, protection of dietary protein from ruminal degradation is expected to result in increased efficiency of protein utilization.

### Example 5

### Palatability

We administered M. citrifolia puree to a group of four pigs. We administered one formulation that contained no additional flavoring and four additional formulations with vary levels of peppermint added. The pigs were watched for more than one hour, but they never indicated any inclination to try any of the versions of the product. They sniffed it a little but did not try to eat it. The pigs do not like the product and will not eat it on their own. We propose that the solution to this problem is to administer the M. citrifolia product as about one percent of the daily ration of these pigs. One percent should make very little if and difference in the flavor of the total feed mixture.

Additionally, we plan to utilized sugar instead of peppermint to flavor the M. citrifolia product. Additionally, we plan to mix the M. citrifolia product with a carrier and then put the carrier through the mixing process with the rest of the feed. For example, if we need to add a gallon of noni product (liquid) to 1,000 lbs. of feed, we could mix a gallon into 100 lbs. of an appropriate carrier ad then the 100 lbs. of carrier could be mixed into the 1,000 lbs. of feed.

We have found that it is easy to mix the puree into the feed ration and the piglet are having no problem eating it. Additionally, we have mixed the M. citrifolia products into milk replacer for some piglets and observe that the piglets on milk replacer have no difficulty eating the M. citrifolia enhanced products under those circumstances. Additionally, we have observed that sows will consume the M. citrifolia product with out a carrier.

### Example 6

### Poultry Trials

The research performed indicated, as discussed below, that M. citrifolia (“Noni”) enhanced diets did no harm and there was about a 3.6% difference in weight gain between the treatment group and the control group.

The efficacy of Noni as a supplement for farm animals under intensive production systems has not previously been explored. A recent limited experiment was conducted with weaned pigs that were drenched with 5 ml liquid Noni supplement twice daily from 5-23 kg live weight. The treatment markedly enhanced pig performance and this prompted interest in Noni as a possible supplement for poultry.

Broiler chickens were selected because of their rapid early growth. Broiler chicks average 40-41 g at day-old and the increase is 3.8, 2.6, 1.8, and 1.6 times previous weeks weight at 1, 2, 3 and 4 weeks of age. Hence a two week experiment represents a period of intense growth and adjustment to the environment. Under praxis conditions a dietary supplement that attenuates the effects of stressors and or improves livability, growth and/or feed efficiency has tremendous market potential. The purpose of the study was to evaluate Noni test material provided by MORINDA, Inc.® in broiler starter diets.

### Materials & Methods

Day-old chicks were winged-banded, weighed and allotted to 24 wire-floored pens in 8 blocks on the basis of initial body weight. The brooder units were maintained in an environment-controlled room with airflow of 60 m³, 18 air changes per hour, and 24 hour photoperiod. The chicks were observed twice daily and water vessels cleaned and refilled daily. Feed and water were provided ad libitum.

The chicks were fed a standard starter diet (control) and liquid Noni supplement added at 1 and 2% in the basal diet. The starter diet contained 58.25% yellow corn, 35% soybean meal, 3.4% poultry fat, 1.4% dicalcium phosphate, 1.1% calcium carbonate, 0.25% common salt, 0.25% vitamin premix, 0.15% choline chloride premix, 0.15% DL-methionine, and 0.05% trace mix. Due to lack of information on stability of the Noni supplement, 150 kg of the control diet was prepared and experimented diets with Noni puree prepared weekly. Feed consumption, body weight, and livability were measured at 2 weeks of age. Broilers are grown on litter and excreta moisture is important for litter condition, birth health, and quality of poultry meant and hence excreta dry matter was measured on days 13-14.

The experiment consisted of three treatments (0, 1, and 2% Noni puree) that were randomly assigned to pens in a randomized complete block design with 8 blocks. A pen of 8-9 birds constituted the experimental unit. Body weights, at one (1) day-old and fourteen (14) days of age, were recorded on an individual basis. The data were subjected to analysis of variance using α=0.05, and orthogonal polynomial contrasts were used to examine response to dose of test material (0, 1 and 2%). In the case of body weight data, the individual values were used to remove the bird variation within each experimental unit and treatment effect tested with the appropriate error term. Means and standard errors are presented in the results section.

### Results

TABLE 1
Performance of Broiler Chicks Fed Noni
Feed Supplement From Day-Old to 14 Days

| | Amount of Noni supplement¹ | | | |
|---|---|---|---|---|
| | in diet (%) | | | |
| Response variable | 0 | 1 | 2 | SEM |
| Body weight at day-old, g | 42.2 | 42.0 | 42.2 | ±0.15 |
| Body weight at 14 days², g | 320 | 326 | 340 | ±10.4 |
| Feed conversion, g feed/g gain | 1.14 | 1.16 | 1.15 | ±0.011 |
| Feed/bird-day from 0-14 days, g | 26.1 | 26.7 | 27.8 | ±0.83 |
| Mean daily gain in weight, g | 19.8 | 19.9 | 21 | ±0.77 |
| Excreta dry matter, % | 42.0 | 43.5 | 43.6 | ±1.77 |

¹Noni animal feed supplement provided by Morinda ®
²Linear contrast (P = 0.19)

Statistically significant (P<0.05) treatment differences in the response variables measured were not detected. There were no abnormalities observed in the birds fed the test material at 1 or 2% of the diet and the use of Noni feed supplement did not increase excreta moisture content. Even though a statistically significant treatment effect was not detected for body weight there was a trend of 3.6% improvement in body weight at 2% Noni feed supplement. The results clearly demonstrated the Noni feed supplement had no adverse effects in terms of behavior, bird condition, moisture excretion, growth, and feed efficiency.

Accordingly our research indicates that 1) noni feed supplement did not have an adverse effect when included at up to 2% in the diet; and 2) a trend in improvement in body weight (3.6% gain) was evident in birds fed the Noni feed supplement at 2%.

These examples and their ingredients, while illustrative of know prior art advances in animal food products, may be significantly enhanced through the inclusion of Morinda citrifolia as an ingredient. By doing so, these products may provide yet further advantages and benefits to the animals for which they are intended. As there exists many different types on animal food products, each containing significantly different compositions of ingredients, the present invention seeks to provide an animal food product the is capable of enhancing any specific composition or formulation by the addition of Morinda citrifolia dietary fiber. As such, several Examples have been provide, which are discussed below, wherein Morinda citrifolia dietary fiber has been added to a specific composition of ingredients to create an enhances and beneficial animal food product.

### Example 7

### Proposed Milking Cows/Mastitis Trials

The present invention contemplates various trials. A non limiting example of a proposed trial includes administering M. citrifolia enhanced products to animals to prevent or ameliorate mastitis. In one proposed trial there is a dairy which milks about 1000 cows twice to three times daily. At any given time they have about 12 head with clinical mastitis. At this dairy clinical mastitis is detected at milking time. Milkers squirt a little milk from each quarter of each cow outside the system before engaging the milking machine. Clinical mastitis will show up immediately in this check. If it is present the milk s taken into a separate canister and not allowed to enter the bulk tank with all the other milk.

On this farm they do not treat infected cows with antibiotics. Instead they make sure that the cows are milked dry each time and test the milk each time. This dairy has a machine at the barn that can take the SCC each milking for each infected cow. When the SCC gets down to the normal range the cow can again be milked into the bulk system, as usual.

This proposed trial would include administering a large dose or “drenching” (“drenching” means giving each cow about a quart or a liter of product at once down the throat of M. citrifolia enhances products to one half of the infected cows on a daily basis, with subsequent monitoring of the SCC for each cow treated, as compared with those infected cows which are not treated. Additionally, this proposed trial contemplates randomly dividing the infected group into two groups. As mastitis clears up in a cow and that cow moves back onto the list of healthy well cows, new cases coming off the healthy list would be divided at random and one half would be treated with the M. citrifolia enhanced product. The proposed trial contemplates “drenching” the animals not treated with the M. citrifolia enhanced product using only pure water.

### Example 8

### Inhibiting COX-2, TNF-α, IL-1β, IL-8 & IL-6

The present invention features compositions and methods for inhibiting COX-2, TNF-α, IL-1β, IL-8 & IL-6. Embodiments of the present invention also comprise methods for internally introducing a Morinda citrifolia composition into the body of a mammal. Several embodiments of the Morinda citrifolia compositions comprise various different ingredients, each embodiment comprising one or more forms of a processed Morinda citrifolia component as taught and explained herein.

The administration of Morinda citrifolia products may modulate endotoxin (lipopolysaccharide, LPS) induced inflammatory responses in equine foal monocytes by regulating cyclo-oxygenase-2 (COX-2) expression, as well as expression of other inflamatory cytokines, specifically TNF-α, IL-1β, and IL-6. A non-limiting example of a Morinda citrifolia product which may be administered is TAHITIAN NONI® EQUINE ESSENTIALS™.

In one exemplary study neonatal foals were enrolled in the study after adequate passive transfer (IgG>800 mg/dl), was confirmed by a SNAP 1 gG test 24 hrs of age. Subsequently, experimental foals (n=2) received 60 ml TAHITIAN NONI™ EQUINE ESSENTIALS™ orally twice daily for 60 days. The 2 remaining foals served as aged matched controls. At days 10 and 60 blood was taken from which peripheral monocytes were isolated. Monocytes from each foal were divided into an untreated control group and a group that was stimulated with LPS for 2 hours at 1000 mg/ml. Quantitive PCR analysis of COX-2, TNF-α, IL-1β, IL-8, IL-6 mRNA expression was determined, expresses as mean relative fold (x), change and the values obtained from control and experimental, foals compared.

At day 10, TAHITINA NON® EQUINE ESSENTIALS™ treated foals has a dramatic fold reduction in COX-2, TNF-α, IL-1β, IL-8 & OL-6 expression in LPS-stimulated monocytes of 23×, 10×, 15×, 30× and 35×, respectively, when compared to age-matched controls.

Although less dramatic than day 10 results, a similar pattern was observed at day 60. TAHITIAN NONI® EQUINE ESSENTIALS™ treated foals had a reduction in COX-2, TNF-α, IL-1β, IL-8 & IL-6 expression in LPS-stimulated monocytes of 9×, 180×, 8.5×, 22× and 35×, respectively, when compared to age-matched controls.

Monocytes isolated from foals receiving TAHITIAN NONI® EQUINE ESSENTIALS™ had markedly decreased COZ-2, TNF-α, IL-1β, IL-8 & IL-6 mRNA expression following LPS stimulation when compared to control foals. Reduction in expression of these pro-inflammatory mediators, most notably at 10 days of age, suggests that TAHITIAN NONI® EQUINE ESSENTIALS™ may be a promising novel anti-inflammatory therapy, warranting further consideration of its use clinically.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed is:

1. A dry form crumble animal food product comprising:
between 0.01% and 30% M. citrifolia pasteurized fruit puree;
between 70% and 99% dry food product; and
an amount of additives from the list consisting of M. citrifolia plus essential amino acids, M. citrifolia plus essential fatty acids, M. citrifolia plus long chain fatty acids, M. citrifolia plus omega 3 fatty acids, M. citrifolia plus omega 6 fatty acids, M. citrifolia plus macro minerals, M. citrifolia plus micro minerals, M. citrifolia plus peptides chains, M. citrifolia plus branched chain amino acids, M. citrifolia puree plus whole noni seeds, M. citrifolia puree plus whole roasted noni seeds, M. citrifolia puree plus whole roasted defatted noni seeds, M. citrifolia puree plus roasted cracked noni seeds defatted, M. citrifolia puree plus roasted cracked noni seeds, M. citrifolia puree plus roasted ground noni seeds. M. citrifolia puree plus roasted ground noni seeds defatted, M. citrifolia puree plus roasted flaked noni defatted seeds, M. citrifolia puree plus roasted flaked noni seeds, M. citrifolia puree plus roasted extruded noni defatted seeds, M. citrifolia puree plus roasted extruded noni seeds and M. citrifolia puree plus extracts from roasted extruded noni seeds.

2. The product of claim 1, further comprising an ingredient selected form a list consisting of:
extract from leaves of Morinda citrifolia, leaf hot water extract, processed Morinda citrifolia leaf ethanol extract, processed Morinda citrifolia leaf stream distillation extract, Morinda citrifolia fruit juice, Morinda citrifolia extract, Morinda citrifolia dietary fiber, Morinda citrifolia puree juice, Morinda citrifolia puree, Morinda citrifolia fruit juice concentrate, Morinda citrifolia puree juice concentrate, freeze concentrated Morinda citrifolia fruit juice, and evaporated concentration of Morinda citrifolia fruit juice, whole Morinda citrifolia fruit in fresh, whole dried Morinda citrifolia fruit, solvent extracted forms of Morinda citrifolia seed, enzymes treated Morinda citrifolia seeds, processed Morinda citrifolia seed, whole Morinda citrifolia fruit, leaf extracts, leaf juice, defatted Morinda citrifolia seed extract and intreated Morinda citrifolia seeds extracts.

3. The product of claim 1 further comprising an ingredient selected from a list comprising: glycosamino glycans, hyrolic acid, glucosamine HCl, glucosamine sulfate, chondroitin sulfate, essential amino acids, essential fatty acids, long chain fatty acids, omega 3 fatty acids, omega 6 fatty acids, amcro minerals, plus micor minerals, peptides chains, branched chain amino acids, whole noni seeds, whole roasted noni seeds, whole roasted defatted noni seeds, roasted cracked noni seeds defatted, roasted cracked noni seeds, roasted ground noni seeds, roasted ground noni seeds defatted, roasted flaked noni defatted seeds, roasted flaked noni seeds, roasted extruded noni defatted seeds, and roasted extruded noni seeds.

4. The product of claim 1, further comprising an active ingredient selected from a group comprising quercetin, rutin, scopoletin, octoanoic acid, potassium, vitamin C, terpenoids, alkaloids, anthraquinones, nordamnacanthal, morindone, rubiandin, B-sitosterol, carotene, vitamin A, flavone glycosides, linoleic acid, Alizarin, amino acids, acubin, L-asperuloside, caprotic acid, caprylic acid, ursolic acid, and putative proxeronines.

5. The product of claim 3, wherein said Quercetin is present in an amount between about 0.1 and 10 percent by weight.

6. The product of claim 3, wherein said Rutin is present in an amount between about 0.1 and 10 percent by weight.

7. A liquid-form animal food product comprising:
between 0.01% and 30% M. citrifolia pasteurized fruit puree;
between 20% and 90% liquid animal food, and
an amount of additives from the list consisting of M. citrifolia plus essential amino acids, M. citrifolia plus essential fatty acids, M. citrifolia plus long chain fatty acids, M. citrifolia plus omega 3 fatty acids, M. citrifolia plus omega 6 fatty acids, M. citrifolia plus macro minerals, M. citrifolia plus micor minerals, M. citrifolia plus peptides chains, M. citrifolia plus branched chain amino acids, M. citrifolia puree plus whole noni seeds, M. citrifolia puree plus whole roasted noni seeds, M. citrifolia puree plus whole roasted defatted noni seeds, M. citrifolia puree plus roasted cracked noni seeds defatted, M. citrifolia puree plus roasted cracked noni seeds, M. citrifolia puree plus roasted ground noni seeds, M. citrifolia puree plus roasted ground noni seeds defatted, M. citrifolia puree plus roasted flaked noni defatted seeds, M. citrifolia puree plus roasted flaked noni seeds, M. citrifolia puree plus roasted extruded noni defatted seeds, and M. citrifolia puree plus roasted extruded noni seeds.

8. The product of claim 6, further comprising an ingredient selected from a list consisting of:
extract from leaves of Morinda citrifolia, leaf hot water extract, processed Morinda citrifolia leaf ethanol extract, processed Morinda citrifolia leaf steam distillation extract, Morinda citrifolia fruit juice, Morinda citrifolia extract, Morinda citrifolia dietary fiber, Morinda citrifolia puree juice, Morinda citrifolia puree, Morinda citrifolia fruit juice concentrate, Morinda citrifolia puree juice concentrate, freeze concentrated Morinda citrifolia fruit juice, and evaporated concentration of Morinda citrifolia fruit juice, whole Morinda citrifolia fruit in fresh, whole dried Morinda citrifolia fruit, solvent extracted forms of Morinda citrifolia seeds, enzyme treated Morinda citrifolia seeds, processed Morinda citrifolia seed, whole Morinda citrifolia fruit, leaf extracts, leaf juice, defatted Morinda citrifolia seed extract and untreated Morinda citrifolia seed extracts.

9. The product of claim 6, further comprising an ingredient selected from a list comprising: glycosaminoglycans, hyaluronic acid, glucosamine HCl, glucosamine sulfate, chondroitin sulfate, essential amino acids, essential fatty acids, long chain fatty acids, omega 3 fatty acids, omega 6 fatty acids, macro minerals, plus micro minerals, peptides chains, branched chain amino acids, whole noni seeds, whole roasted noni seeds, whole roasted defatted noni seeds, roasted cracked noni seeds defatted, roasted cracked noni seeds, roasted ground noni seeds, roasted ground noni seeds defatted, roasted flaked noni defatted seeds, roasted flaked noni seeds, roasted extruded noni defatted seeds, and roasted extruded noni seeds.

10. The formulation of claim 6, further comprising and active ingredient selected from a group comprising quercetin, rutin, scopoletin, octoanoic acid, potassium, vitamin C, terpenoids, alkaloids, anthraquinones, nordamnacanthal, morindone, rubiandin, B-sitosterol, carotene, vitamin A, flavone glycosides, linoleic acid, alizarin, amino acids, acubin, L-asperuloside, caproic acid, caprylic acid, ursolic acid, and putative proxeronines.

11. The product of claim 9, wherein said Quercetin is present in an amount between about 0.1 and 10 percent by weight.

12. The product of claim 9, wherein said Rutin is present in an amount between about 0.1 and 10 percent by weight.

13. A Morinda citrifolia -based dry food product comprising pasteurized Morinda citrifolia fruit puree mixed with dry form animal food and additives having a form from the list consisting of pellets, extruded nuggets, extruded flakes, sinking nuggets, delivery in liquid form via a water system or lick tank system, semi-solid and gelatinous forms, low moisture gels, low moisture gel pellets, crumble, mash, loose feed, and sweet feed.

14. the product of claim 12, further comprising an amount of additives from the list consisting of M. citrifolia plus essential amino acids, M. citrifolia plus essential fatty acids, M. citrifolia plus long chain fatty acids, M. citrifolia plus omega 3 fatty acids, M. citrifolia plus omega 6 fatty acids, M. citrifolia plus macro minerals, M. citrifolia plus micro minerals, M. citrifolia plus peptides chains, M. citrifolia plus branched chain amino acids, M. citrifolia puree plus whole noni seeds, M. citrifolia puree plus whole roasted noni seeds, M. citrifolia puree plus whole roasted defatted noni seeds, M. citrifolia puree plus roasted cracked noni seeds defatted, M. citrifolia puree plus roasted cracked noni seeds, M. citrifolia puree plus roasted ground noni seeds, M. citrifolia puree plus roasted ground noni seeds defatted, M. citrifolia puree plus roasted flaked noni defatted seeds, M. citrifolia puree plus roasted flaked noni seeds, M. citrifolia puree plus roasted extruded noni defatted seeds, and M. citrifolia puree plus roasted extruded noni seeds.

15. The product of claim 12, further comprising an ingredient selected from a list consisting of:
extract from leaves of Morinda citrifolia, leaf hot water extract, processed Morinda citrifolia leaf ethanol extract, processed Morinda citrifolia leaf steam distillation extract, Morinda citrifolia fruit juice, Morinda citrifolia extract, Morinda citrifolia dietary fiber, Morinda citrifolia puree juice, Morinda citrifolia puree, M. citrifolia fruit juice concentrate, Morinda citrifolia puree juice concentrate, freeze concentrated Morinda citrifolia fruit juice, an evaporated concentration of Morinda citrifolia fruit juice, whole Morinda citrifolia fruit in fresh, whole dried Morinda citrifolia fruit, solvent extracted forms of Morinda citrifolia seeds, enzyme treated Morinda citrifolia seeds, processed Morinda citrifolia seed, whole Morinda citrifolia fruit, leaf extracts, leaf juice, defatted Morinda citrifolia seed extract and untreated Morinda citrifolia seed extracts.

16. The product of claim 12, further comprising an ingredient selected from a list comprising glycosaminoglycans, hyaluronic acid, glucosamine HCl, glucosamine sulfate, chondroitin sulfate, essential amino acids, essential fatty acids, long chain fatty acids, omega 3 fatty acids, omega 6 fatty acids, macro minerals, plus micro minerals, peptide chains, branched chain amino acids, whole noni seeds, whole roasted noni seeds, whole roasted defatted noni seeds, roasted cracked noni seeds defatted, roasted cracked noni seeds, roasted ground noni seeds, roasted ground noni seeds defatted, roasted flaked noni defatted seeds, roasted flaked noni seeds, roasted extruded noni defatted seeds, and roasted extruded noni seeds.

17. The formulation of claim 12, further comprising an active ingredient from a group comprising quercetin, rutin, scopoletin, octoanoic acid, potassium, vitamin C, terpenoids, alkaloids, anthraquinones, nordamnacanthal, moridone, rubiandin, B-sitosterol, carotene, vitamin A, flavone glycosides, linolec acid, Alizarin, amino acids, acubin, L-asperuloside, caproic acid, caprylic acid, ursolic acid, and putative proxeronines.

18. The product of claim 16, wherein said Quercetin is present in an amount between about 0.1 and 10 percent by weight.

19. product of claim 16, wherein said Rutin is present in an amount between about 0.1 and 10 percent by weight.

20. A method for feeding animals comprising the steps of:
adding a processed Morinda citrifolia product to an alcohol-based solution;
isolating and extracting an active ingredient of said processed Morinda citrifolia product from said solution;
mixing said extracted active ingredient with other feed ingredients; and
administering said feed to said animal.

21. The method of claim 19, wherein said processed Morinda citrifolia product comprises processed Morinda citrifolia fruit juice.

22. The method of claim 19, wherein said processed Morinda citrifolia product comprises processed Morinda citrifolia puree.

23. The method od claim 19, wherein said alcohol-based solution is selected from the group consisting essentially of methanol, ethanol, and ethyl acetate, and other alcohol-based derivatives.

24. The method of claim 19, wherein said active ingredient is Quercetin.

25. The method of claim 23, wherein said active ingredient is Rutin that synergistically works with said Quercetin.
